(19) United States
(12) Patent Application Publication
(10) Pub. No.: US 2012/0151082 A1
(43) Pub. Date: Jun. 14, 2012

(54) APPARATUS AND METHOD FOR PROVIDING STREAMING SERVICE IN A PORTABLE TERMINAL

(75) Inventors: Seong-Min Kang, Hwaseong-si (KR); Sang-Hyun Shin, Yongin-si (KR)

(73) Assignee: SAMSUNG ELECTRONICS CO., LTD, Suwon-si (KR)

(21) Appl. No.: 13/326,227

(22) Filed: Dec. 14, 2011

(30) Foreign Application Priority Data
Dec. 14, 2010 (KR) 10-2010-0127505

(51) Int. Cl. G06F 15/16

(52) U.S. Cl. 709/231

(57) ABSTRACT

An apparatus and method for providing a streaming service in a portable terminal are provided. The apparatus includes a communication unit, a memory unit, a display unit, a header analyzer, a state identifying unit, and a controller. The communication unit communicates with a streaming server and receives tracks constituting data. The memory unit stores the received tracks. The display unit reproduces and outputs the received tracks. The header analyzer identifies an array state of the tracks. The state identifying unit identifies a storage state of the stored tracks. The controller determines a change or non-change of a reception scheme of data, and receives the data in the determined data reception scheme. The data request unit sends a request for tracks to the streaming server.

### CROSS-REFERENCE TO RELATED APPLICATION(S) AND CLAIM OF PRIORITY

The present application is related to and claims priority under 35 U.S.C. §119(a) to a Korean patent application filed in the Korean Intellectual Property Office on Dec. 14, 2010 and assigned Serial No. 10-2010-0127505, the contents of which are herein incorporated by reference.

### TECHNICAL FIELD OF THE INVENTION

The present invention relates to communication services, and more particularly, to an apparatus and method for providing a streaming service in a portable terminal.

### BACKGROUND OF THE INVENTION

in recent years, portable terminals, such as cell phones, have become widely used. Service providers and terminal manufacturers are continually developing new products and/or services for consumers.

For example, portable terminals have evolved to include multimedia equipment for phone books, games, short messages, electronic mail (e-mail) messages, morning wakeup calls, MPEG-1 Audio Layer 3 (MP3) players, schedule management functions, digital cameras, multimedia messages and wireless Internet services, and provide a variety of services.

Recently, Wireless Fidelity (WiFi) terminals having wireless Local Area Network (LAN) functions have been developed for access to e-mail, web sites, streaming media, and the like. That is, WiFi terminals wirelessly provides broadband Internet access for rapid online access in a home and office environment, and during movement.

Streaming is a technology for processing transmitted in a manner somewhat similar to a seamless and continuous flow of water. The streaming technology becomes of more significant along with the growth of the Internet. This is because most users do not have a sufficiently fast streaming speed to download large capacities of multimedia files. By using streaming technology however, a client browser or plug-in can begin to display useful data even before all files are downloaded.

The recent proliferation of 3-Generation/High Speed Downlink Packet Access (3G/HSDPA) networks make it possible to provide a relatively high speed data service to users that may allow a relatively convenient streaming service.

During use of the streaming service, the portable terminal receives packets forwarded by a streaming server, decodes the packets, and outputs audio information and video information on a screen together.

FIG. 1 illustrates an example configuration of data used in a general streaming service.

Referring to FIG. 1, the data can include a Moving Picture Experts Group 4 (MPEG4) file of a streaming service. The data 100 can be composed of MOOV portion corresponding to a header region 102 and MDAT portion corresponding to a data region 104. The MDAT portion can be composed of multiple video tracks 106 and audio tracks 108.

The header region 102, which includes header information including track information of data that a portable terminal intends to receive, includes information on a track start position and data format of each audio 108 and video 106 tracks. The data region 104 includes tracks reproduced by a streaming service.

The tracks 106 and 108 are data received and reproduced by a portable terminal. Generally, the portable terminal makes requests for data in the form of the tracks 106 and 108 constituting the data region 104.

That is, as illustrated in FIG. 1, the portable terminal analyzes header region 102 information and, after receiving video #1 track 106, receives audio #1 track 108. However, in certain cases where the data region 104 is not configured in a regular array of video and audio tracks, if the video or audio track is received without consideration of a particular track format (i.e., a video/audio), the video and audio tracks may get out of synchronization within the terminal such that only the video or audio is reproduced.

A method for changing reception order of the video/audio tracks according to a format of data has been proposed. But, whenever the reception order changes as described above, a Transmission Control Protocol (TCP) connection reset is typically carried out that in many cases, causes a problem of a delay of the streaming service.

### SUMMARY OF THE INVENTION

To address the above-discussed deficiencies of the prior art, it is a primary object to provide at least the advantages below. Accordingly, one aspect of the present invention is to provide an apparatus and method for providing a streaming service in a portable terminal.

Another aspect of the present invention is to provide an apparatus and method for changing a data reception scheme to synchronize tracks with each other in a portable terminal.

A further aspect of the present invention is to provide an apparatus and method for identifying a state of tracks stored in a buffer and changing a data reception scheme in a portable terminal.

The above aspects are achieved by providing an apparatus and method for providing a streaming service in a portable terminal.

In accordance with an aspect of the present invention, an apparatus for providing a streaming service in a portable terminal is provided. The apparatus includes a communication unit, a memory unit, a display unit, a header analyzer, a state identifying unit, and a controller. The communication unit communicates with a streaming server and receives tracks constituting data from the streaming server. The memory unit stores the received tracks over a specified period of time. The display unit reproduces and outputs the tracks received from the streaming server. The header analyzer identifies an array state of the tracks constituting the data. The state identifying unit identifies a storage state of the tracks stored in the memory unit and provides the storage state to the controller. The controller determines a change or non-change of a reception scheme of data received from the streaming server using the array state of the tracks and the storage state of the tracks, and receives the data according to the determined data reception scheme. The data request unit sends a request for tracks to the streaming server in the data reception scheme resulting from the determined result of the controller.

In accordance with another aspect of the present invention, a method for providing a streaming service in a portable terminal is provided. The method includes communicating with a streaming server and receiving tracks constituting data from the streaming server, storing the received tracks over a specified period of time, identifying a track array state of data intended to be received from the streaming server, identifying a storage state of the tracks stored during the predetermined time, determining a change or non-change of a reception scheme of the data received from the streaming server using the track array state and the storage state of the tracks, sending a request for tracks to the streaming server in the data reception scheme resulting from the determination result, and reproducing and outputting the tracks received from the streaming server.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example configuration of data used in a general streaming service;

FIG. 2 illustrates an example portable terminal for receiving a streaming service according to one embodiment of the present invention;

FIG. 3 illustrates an example process of using a streaming service in a portable terminal according to an embodiment of the present invention;

FIG. 4 illustrates an example process for identifying whether there is a need for a change of a data reception scheme in a portable terminal according to an embodiment of the present invention; and

FIG. 5 illustrates an example process for providing a streaming service in a mobile communication system according to an embodiment of the present invention.

Throughout the drawings, like reference numerals will be understood to refer to like parts, components and structures.

### DETAILED DESCRIPTION OF THE INVENTION

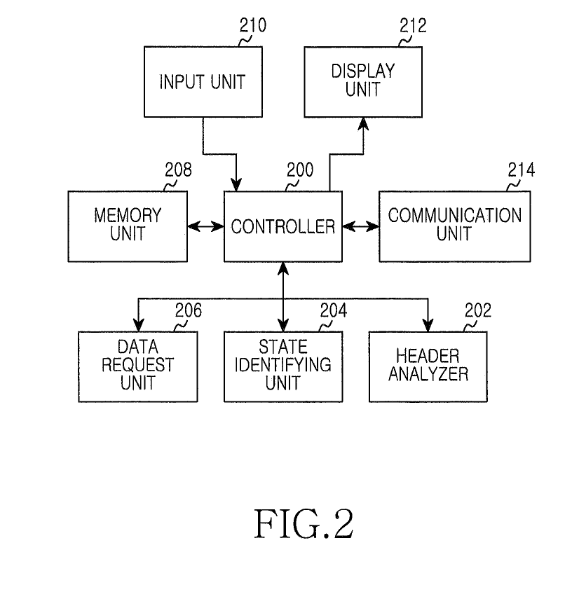

FIGS. 2 through 5, discussed below, and the various embodiments used to describe the principles of the present disclosure in this patent document are by way of illustration only and should not be construed in any way to limit the scope of the disclosure.

Preferred embodiments of the present invention will be described herein below with reference to the accompanying drawings. In the following description, well-known functions or constructions are not described in detail since they may obscure the invention in unnecessary detail.

An apparatus and method for changing a data reception scheme according to a storage state of tracks, synchronizing the tracks with each other, and improving streaming performance in a portable terminal according to the present invention are described below.

FIG. 2 illustrates an example portable terminal for receiving a streaming service according to one embodiment of the present invention.

Referring to FIG. 2, the portable terminal can include a controller 200, a header analyzer 202, a state identifier 204, a data request unit 206, a memory unit 208, an input unit 210, a display unit 212, and a communication unit 214.

The controller 200 of the portable terminal controls the general operation of the portable terminal. For example, the controller 200 performs processing and control for voice calls and data communication. In addition, according to the present invention, the controller 200 identifies data received and stored according to a streaming service during specified periods of time while using the streaming service and changes a data reception scheme of the received data.

That is, in a case where the portable terminal reproduces stored data, when video and audio tracks are out of synchronization, the controller 200 changes a data reception scheme to synchronize the tracks with each other.

The header analyzer 202 receives header information on data associated with a streaming service from a streaming server and identifies an array state of tracks constituting the data.

The state identifier 204 identifies a storage state of the tracks received from the streaming server and provides the identified state to the controller 200. According to this, the controller 200 can determine a change or non-change of a reception scheme of data received from the streaming server.

The data request unit 206 requests for data to be received in the changed reception scheme resulting from the identified state from the state identifying unit 204. That is, in a case where any one kind of the tracks among the stored video and audio tracks are received out of synchronization, the data request unit 206 issues a request for regular data reception to synchronize the non-synchronized tracks with each other.

The memory unit 208 comprises any suitable storage medium such as a Read Only Memory (ROM), a Random Access Memory (RAM), and a flash ROM. The ROM stores instructions of a program for processing and controlling the controller 200, the header analyzer 202, the state identifier 204, and the data request unit 206 along with a variety of reference data.

The RAM, a working memory of the controller 200, stores temporary data generated in execution of a variety of programs. The flash ROM stores a diversity of updateable depository data such as a phone book, an incoming/outgoing message, meta data and a data storing database, and may include a buffer for storing received tracks according to the present invention.

The input unit 210 may include numeral key buttons ‘0’ to ‘9’, a menu button, a cancel button, an OK button, a talk button, an end button, an Internet button, navigation key (or direction key) buttons, and a plurality of function keys such as a character input key. The input unit 210 provides key input data corresponding to a key pressed by a user to the controller 200.

The display unit 212 displays state information generated during operation of the portable terminal, such as alpha-numeric characters, moving pictures, still pictures, and the like. According to the present invention, the display unit 212 may also reproduce data of tracks being out of synchronization. The display unit 212 may be a color Liquid Crystal Display (LCD), an Active Matrix Organic Light Emitting Diode (AMOLED), and the like. In one embodiment, the display unit 212 may includes a touch input device such that the display unit 212 can be used as an input device.

The communication unit 214 transmits/receives and processes wireless signals through an antenna (not illustrated). For example, in a transmission mode, the communication unit 214 processing original data through channel coding and spreading, converting the original data into Radio Frequency (RF) signals, and transmits the RF signal through the antenna. In a reception mode, the communication unit 214 converts received RF signals into baseband signals, processes the baseband signals through despreading and channel decoding, and restores the signal to original data.

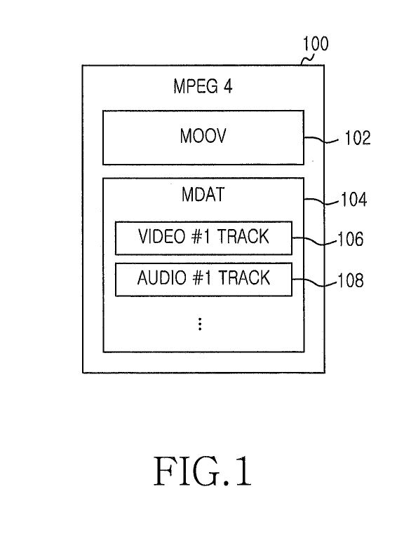

In certain embodiments, the roles of the header analyzer 202, the state identifier 204, and the data request unit 206 can be carried out by the controller 200 of the portable terminal. However, these are shown separately in FIG. 1 for convenience of description, and should not limit the scope of the present invention. It should be understood by those skilled in the art that various modifications of construction can be made within the scope of the present invention. For example, the portable terminal may be configured such that all of these functions are processed by the controller 200.

A server providing a streaming service to the portable terminal transmits data according to a data reception method selected by the portable terminal. The server stores a plurality of data to be provided through the streaming service. Also, the server can be a multimedia terminal supporting a network function.

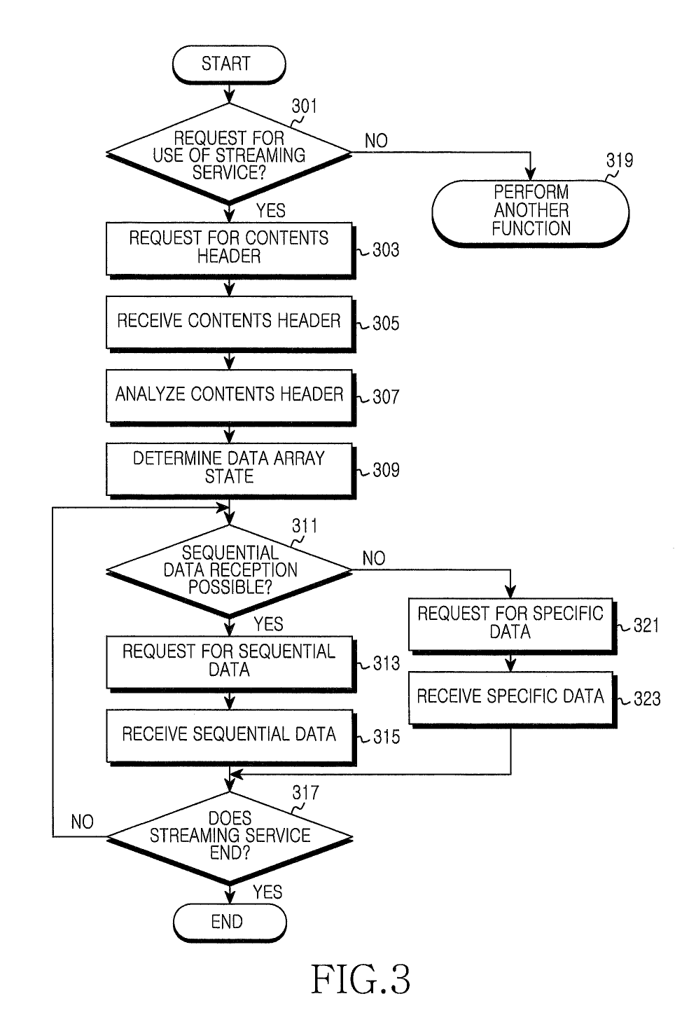

FIG. 3 illustrates an example process for using a streaming service in a portable terminal according to an embodiment of the present invention.

Referring to FIG. 3, in step 301, the portable terminal identifies a request of a user intending to use a streaming service. If the request of the user intending to use the streaming service is not identified, the portable terminal proceeds to step 319 and performs another function such as a wait mode or other task. However, if the request of the user intending to use the streaming service is identified in step 301, the portable terminal proceeds to step 303 and sends a request for a contents header about data to be received, to a server providing the streaming service. Here, the server providing the streaming service stores a plurality of data to be provided through the streaming service, and can also be a multimedia terminal supporting a network function.

The portable terminal then proceeds to step 305 and receives the contents header from the server. The header received from the server, which includes header information having track information of data that the portable terminal intends to receive, includes information on a track start position and data format of each audio and video data track.

The portable terminal then proceeds to step 307 and analyzes the header received from the server and then, proceeds to step 309 and identifies an array state of the data. In detail, the portable terminal identifies an array state of tracks constituting data intended to be received through the streaming service. At this time, the portable terminal identifies the array state of the tracks constituting the data in parallel with a process of receiving real data such that the portable terminal may process the streaming data in a relatively smooth, even manner.

The portable terminal then proceeds to step 311 and determines if sequential data reception is possible. Here, determining if the sequential data reception is possible includes determining if a current data reception scheme can maintain synchronization of received audio and video tracks. The sequential data reception refers to sequentially receiving multiple tracks constituting data. In detail, the sequential data reception refers to a method of receiving in order of video #1 track, audio #1 track, audio #2 track, and video #2 track in a case of using a streaming service for data composed of video #1 track, audio #1 track, audio #2 track, and video #2 track.

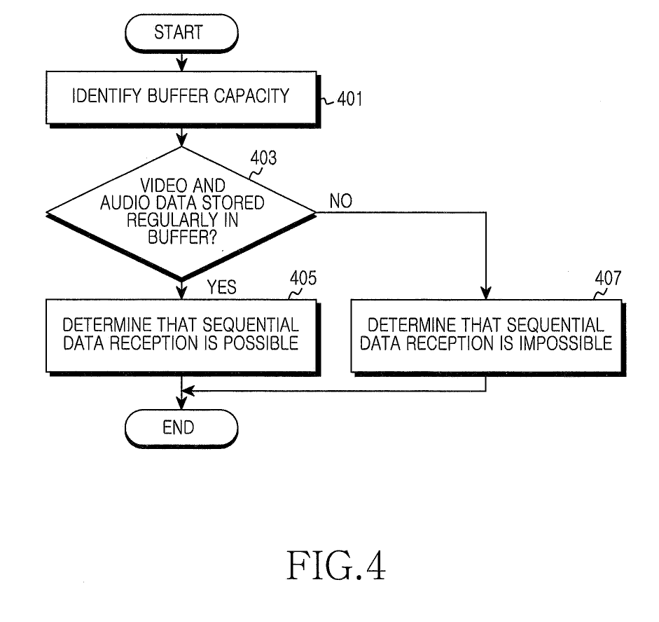

The streaming service, which receives and reproduces data from a streaming server, stores received video track and audio track in a buffer. If the video and audio tracks are stored regularly in the buffer, video and audio associated with the video and audio tracks may be outputted simultaneously. In contrast, if the video and audio tracks are not stored regularly in the buffer, the video and audio become unsynchronized. For example, in a case where video #1 track, audio #1 track, and audio #2 track are stored sequentially in the buffer, a video and audio for #1 track may be in synchronization with each other, but the #2 track in only outputted due to lack of the #2 track video data. In a case where the video and audio tracks are stored regularly as above, it can be determined that the sequential data reception is possible. This is described below in detail in FIG. 4.

If it is determined in step 311 that the current data reception scheme can maintain the situation in which the audio and video are synchronized, the portable terminal proceeds to step 313 and sends a sequential data request to the server. The portable terminal then proceeds to step 315 and receives tracks according to the sequential data request from the server. In contrast, if it is determined in step 311 that the current data reception scheme cannot maintain synchronization of the audio and video tracks, the portable terminal proceeds to step 321 and sends a request for specific data to the server. The portable terminal then proceeds to step 323 and receives tracks according to the specific data request, from the server. Here, the process of sending the request for specific data refers to a scheme of requesting tracks such that a video and an audio may be reproduced in synchronization with each other.

The portable terminal receiving tracks according to a data reception method as above proceeds to step 317 and identifies if the streaming service ends. If it is identified in step 317 that the streaming service does not end, the portable terminal returns to step 311 to continually process the received streaming data to prevent the audio and video tracks from getting out of synchronization during the streaming service. In contrast, if it is identified in step 317 that the streaming service ends, the portable terminal terminates the algorithm according to the present invention.

FIG. 4 illustrates an example process of identifying whether there is a need for a change of a data reception scheme in a portable terminal according to an embodiment of the present invention.

Referring to FIG. 4, in step 401, the portable terminal identifies a capacity of a buffer that stores tracks constituting streaming data. Here, the portable terminal continuously identifies the buffer capacity during a streaming service, that is, identifies a storage state of the stored data.

The portable terminal then proceeds to step 403 and identifies if video and audio tracks (i.e., video and audio data) have been stored regularly in the buffer. Here, the video and audio tracks being stored regularly in the buffer means that an audio and a video tracks are synchronized with each other when using the streaming service according to the stored tracks.

If it is identified in step 403 that the video and audio tracks are not stored regularly, the portable terminal proceeds to step 407 and determines that sequential data reception is impossible, and therefore determines that there is a need to change a data reception scheme. In contrast, if it is identified in step 403 that the video and audio tracks are stored regularly, the portable terminal proceeds to step 405 and determines that sequential data reception is possible, and therefore determines that there is no need to change the data reception scheme.

After identifying if there is the need to change the data reception scheme as above, the portable terminal terminates the algorithm according to the present invention.

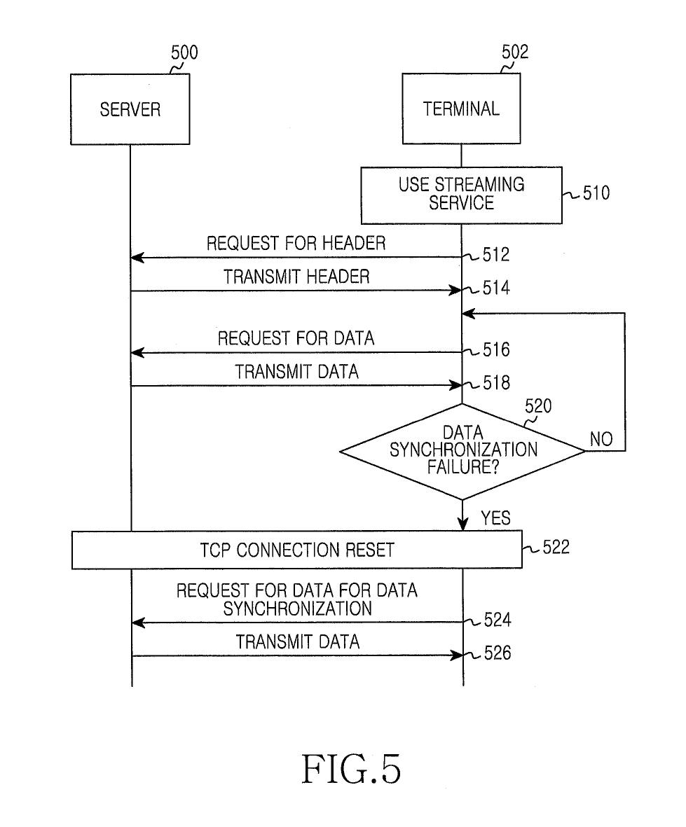

FIG. 5 illustrates an example process of providing a streaming service in a mobile communication system according to an embodiment of the present invention.

Referring to FIG. 5, the mobile communication system includes a server 500 providing a streaming service and a terminal 502 receiving the streaming service. The server 500 stores a plurality of data to be provided through the streaming service may be a multimedia terminal supporting a network function.

First, in step 510, the terminal 502 identifies if a user will use the streaming service.

If it is identified in step 510 that the user intends to use the streaming service, in step 512, the terminal 502 sends a request for a header to the server 500 and, in step 514, the terminal 502 receives the header from the server 500.

In step 516, the terminal 502 sends a request for tracks constituting data that the user intends to reproduce, to the server 500. In step 518, the terminal 502 receives the tracks from the server 500. The data is composed of a plurality of video tracks and audio tracks, in which the tracks may or may not be received and reproduced sequentially.

In general, the data is constructed by receiving video tracks and audio tracks in a regular order, so the terminal 502 may receive and store the tracks sequentially.

In certain situations however, the tracks may be received in an irregular order such that the video and audio tracks are out of synchronization.

Accordingly, in step 520, the terminal 502 identifies if a data synchronization failure situation occurs while using the streaming service according to the present invention. Here, the data synchronization failure situation refers to a situation where the audio and the video tracks are received out of synchronization as mentioned earlier.

If the data synchronization failure situation does occur in step 520, the terminal 502 continues the data reception method of receiving tracks sequentially. However, if the data synchronization failure situation occurs in step 520, in step 524, the terminal 502 changes a data reception sequence synchronizing the data and sends a data request to the server 500. In step 526, the terminal 502 receives data according to the request, from the server 500.

For one example, in a case where the terminal 502 receives tracks sequentially but stores only video data, the terminal 502 changes a data reception sequence and sends a request for also receiving audio data associated with the video data to the server 500.

At this time, step 524 of changing the data reception sequence for synchronizing the data is carried out after step 522 for performing a TCP connection reset only in the data synchronization failure situation.

As described above, exemplary embodiments of the present invention are for changing a data reception scheme according to a track storage state, thereby synchronizing tracks with each other and improving streaming performance in a portable terminal. The exemplary embodiments of the present invention provide a smooth streaming service by, in course of receiving and storing tracks sequentially, identifying the track storage state to identify if the tracks are out of synchronization and, only if the tracks are out of synchronization, making a request for a specific track.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for providing a streaming service in a portable terminal, the apparatus comprising:
a communication unit configured to receive tracks constituting data from the streaming server;
a memory unit configured to store the received tracks over a specified period of time;
a display unit configured to reproduce and output the tracks received from the streaming server;
a header analyzer configured to identify an array state of the tracks constituting the data;
a state identifying unit configured to identify a storage state of the tracks stored in the memory unit and provide the storage state to a controller;
the controller configured to determine a change or non-change of a reception scheme of data received from the streaming server using the array state of the tracks and the storage state of the tracks, and receive the data according to the determined data reception scheme; and
a data request unit configured to send a request for tracks to the streaming server in the data reception scheme according to the determined result of the controller.

2. The apparatus of claim 1, wherein the state identifying unit is configured to identify whether an audio track or a video track have been regularly stored and determine the change or non-change of the data reception scheme.

3. The apparatus of claim 2, wherein the state identifying unit is configured to identify whether the audio track or the video track are out of synchronization and determine the change or non-change of the data reception scheme.

4. The apparatus of claim 1, wherein the controller is configured to receive tracks constituting the data sequentially when the audio track and the video track have been stored regularly.

5. The apparatus of claim 1, wherein the controller is configured to control receive a track having a specific position, and synchronize the tracks with each other when the audio track and the video track have not been stored regularly.

6. The apparatus of claim 1, wherein the streaming server comprises a multimedia terminal supporting a network function, the multimedia terminal storing a plurality of data to be provided through the streaming service.

7. A method for providing a streaming service in a portable terminal, the method comprising:
receiving tracks constituting data from a streaming server;
storing the received tracks over a specified period of time;
identifying a track array state of the data intended to be received from the streaming server;
identifying a storage state of the tracks stored during the specified period of time;
determining a change or non-change of a reception scheme of the data received from the streaming server using the track array state and the storage state of the tracks;
sending a request for tracks to the streaming server in the data reception scheme according to the determined result; and
reproducing and outputting the tracks received from the streaming server.

8. The method of claim 7, wherein identifying the track array state of the data intended to be received from the streaming server comprises identifying the state of the stored tracks and identifying if an audio track and a video track have been regularly stored.

9. The method of claim 8, wherein identifying the track array state of the data intended to be received from the streaming server comprises identifying if the audio track and the video track have been regularly stored such that the audio track and the video track remain in synchronization.

10. The method of claim 7, wherein sending the request for tracks to the streaming server in the data reception scheme comprises making a request for receiving tracks sequentially when the audio track and the video track have been stored regularly.

11. The method of claim 7, wherein sending the request for tracks to the streaming server in the data reception scheme comprises making a request for receiving a track of a specific position to synchronize the tracks with each other when the audio track and the video track have not been stored regularly.

12. The method of claim 7, wherein the streaming server comprises a multimedia terminal supporting a network function, the multimedia terminal having stored a plurality of data to be provided through the streaming service.

13. A computer readable medium embodying a computer program, the computer program comprising computer readable program code for:
receiving tracks constituting data from a streaming server;
storing the received tracks over a specified period of time;
identifying a track array state of the data received from the streaming server;
identifying a storage state of the tracks stored during the specified period of time;
determining a change or non-change of a reception scheme of the data received from the streaming server using the track array state and the storage state of the tracks;
sending a request for tracks to the streaming server in the data reception scheme according to the determined result; and
reproducing and outputting the tracks received from the streaming server.

14. The computer readable medium of claim 13, wherein identifying the track array state of the data received from the streaming server comprises identifying the state of the stored tracks and identifying if an audio track and a video track have been regularly stored.

15. The computer readable medium of claim 14, wherein identifying the track array state of the data received from the streaming server comprises identifying if the audio track and the video track have been regularly stored such that the audio track and the video track remain in synchronization.

16. The computer readable medium of claim 13, wherein sending the request for tracks to the streaming server in the data reception scheme comprises making a request for receiving tracks sequentially when the audio track and the video track have been stored regularly.

17. The computer readable medium of claim 13, wherein sending the request for tracks to the streaming server in the data reception scheme comprises making a request for receiving a track of a specific position to synchronize the tracks with each other when the audio track and the video track have not been stored regularly.

18. The computer readable medium of claim 13, wherein the streaming server comprises a multimedia terminal supporting a network function, the multimedia terminal having stored a plurality of data to be provided through the streaming service.

19. The computer readable medium of claim 13, wherein the computer program is executed on a portable terminal.

20. The computer readable medium of claim 13, wherein the tracks are received from the streaming server over the Internet.
